(19) United States
(12) Patent Application Publication
(10) Pub. No.: US 2007/0146114 A1
(43) Pub. Date: Jun. 28, 2007

(54) Trim resistor assembly and method for making the same

(76) Inventor: Charles Scott Nelson, Fenton, MI (US)

Correspondence Address: DELPHI TECHNOLOGIES, INC., M/C 480-410-202, PO BOX 5052, TROY, MI, 48007, US

(21) Appl. No.: 11/321,927

(22) Filed: Dec. 28, 2005

(51) Int. Cl. H01C 10/00

(52) U.S. Cl. 338/195

(57) ABSTRACT

A resistor assembly, comprising: a first housing portion, the first housing portion having a receiving area on one side of the first housing portion; a trim resistor element disposed in the receiving area, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film; a pair of lead wires, one of the pair of lead wires being electrically terminated with one of the pair of conductive areas and the other one of the pair of lead wires being secured to the other one of the pair of conductive areas; and a second housing portion, the second housing portion having a first access opening and a second access opening, the second housing portion being disposed over the receiving area after the trim resistor element has been located therein, wherein the first access opening is located over a portion of the pair of conductive areas and a portion of the pair of lead wires electrically terminated to the portion of the conductive areas, wherein a first sealing compound is disposed in the first access opening to cover the portion of the conductive areas and the portion of the pair of lead wires located in the first access opening, and the second access opening is located over the trimable resistive film, wherein a second sealing compound is disposed in the second access opening after a portion of the trimable resistive film is removed to provide a desired resistance between the pair of conductive areas.

### TECHNICAL FIELD

The present invention relates to trim resistors and methods of making the same.

### BACKGROUND

Exhaust systems include exhaust sensors positioned to monitor the exhaust gases of the exhaust system. The exhaust sensors are typically associated with a controller comprising microelectronics in order to provide signals and/or commands to components of the exhaust system. Some exhaust sensors require a compensation resistor to be associated with the exhaust sensor and the electronics of the exhaust system in order to provide signals to the controller of the exhaust system in order to compensate for part-to-part variability in the sensor itself.

In the past, there have been two ways to do this. The first being the use of a resistor having a discrete fixed value or resistance. However, using such resistor will almost never allow for a perfect match with an associated system, as there are variations in the sensors. The second way of providing a compensation resistor is to use a trim resistor, wherein a laser is used to remove portions of a resistive film comprising the resistive path by removing portions of the resistive surface until a desired resistance is achieved. The use of a trimable resistor requires a single part having a trimable resistive element wherein the same is adjusted to precisely match the desired resistance of the system the resistor is used in. Current methods of using trim resistors with exhaust sensors is to integrate the trim resistor into the offend connector, which is typically used to connect the resistor to the rest of the sensor system. While this is compact, it is not flexible to customers needs if they wish to use a different connector. In addition, resistor assemblies further require sealants and/or protective coverings to be disposed over the trimable resistive element and its wire terminations.

In addition, the ability to seal against some wires used with these assemblies require special sealants, especially resistor assemblies having PTFE cables, which are typically used in exhaust gas sensors. Moreover, previous resistor assemblies did not have features to capture other wires from the sensor, which are not directly electrically terminated to the trimable resistive element. In addition, these wires can interfere with the laser trimming operation if they get in the way of the trim window.

Prior attempts have used an insulation displacement technique (IDC) (Insulation Displacement Connection) and a sealing cap to make the trim resistor. However, these devices are large and cumbersome and cannot be inserted under a conventional exhaust sensor wire sheath or sleeve, in order to protect the trim resistor from getting snagged.

Accordingly, it is desirable to provide a trimable resistor assembly for use with various systems including but not limited to exhaust sensors in exhaust systems. Moreover, it is desirable to provide a trimable resistor assembly and method of making the same wherein the resistor assembly is capable of being adapted to various uses via trimming process and thereafter being sealed within a protective covering.

### SUMMARY OF THE INVENTION

A resistor assembly, comprising: a first housing portion, the first housing portion having a receiving area on one side of the first housing portion; a trim resistor element disposed in the receiving area, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film; a pair of lead wires, one of the pair of lead wires being electrically terminated with one of the pair of conductive areas and the other one of the pair of lead wires being secured to the other one of the pair of conductive areas; and a second housing portion, the second housing portion having a first access opening and a second access opening, the second housing portion being disposed over the receiving area after the trim resistor element has been located therein, wherein the first access opening is located over a portion of the pair of conductive areas and a portion of the pair of lead wires electrically terminated to the portion of the conductive areas, wherein a first sealing compound is disposed in the first access opening to cover the portion of the conductive areas and the portion of the pair of lead wires located in the first access opening, and the second access opening is located over the trimable resistive film, wherein a second sealing compound is disposed in the second access opening after a portion of the trimable resistive film is removed to provide a desired resistance between the pair of conductive areas.

A resistor assembly, comprising: a first housing portion, the first housing portion having a receiving area on one side of the first housing portion; a trim resistor element disposed in the receiving area, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film; a third conductive area disposed on the non-conductive substrate, the third conductive area being in direct electrical communication with one of the pair of conductive areas; a pair of lead wires, one of the pair of lead wires being electrically terminated with one of the pair of conductive areas and the other one of the pair of lead wires being secured to the other one of the pair of conductive areas; a third lead wire electrically terminated with the third conductive area; and a second housing portion, the second housing portion having a first access opening, a second access opening and a third access opening, the second housing portion being disposed over the receiving area after the trim resistor element has been located therein, wherein the first access opening is located over a portion of the pair of conductive areas and a portion of the pair of lead wires electrically terminated to the portion of the conductive areas, wherein a first sealing compound is disposed in the first access opening to cover the portion of the conductive areas and the portion of the pair of lead wires located in the first access opening, and the second access opening is located over the trimable resistive film, wherein a second sealing compound is disposed in the second access opening after a portion of the trimable resistive film is removed to provide a desired resistance between the pair of conductive areas and the third access opening is located over a portion of the third conductive area and a portion of the third lead wire electrically terminated to a portion of the third conductive area, wherein the first sealing compound is also disposed in the third access opening to cover the portion of the third conductive area and the portion of the third lead wire located in the third access opening.

A method for providing a resistor assembly, the method comprising: disposing a trim resistor within a receiving area of a first housing portion, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film and a third conductive area disposed on the non-conductive substrate, the third conductive area being in direct electrical communication with one of the pair of conductive areas; terminating a pair of lead wires to the trim resistor element, one of the pair of lead wires being electrically terminated with one of the pair of conductive areas and the other one of the pair of lead wires being secured to the other one of the pair of conductive areas; terminating a third lead wire with the third conductive area; securing a second housing portion to the first housing portion after the trim resistor element is disposed in the receiving area, the second housing portion having a first access opening, a second access opening and a third access opening, wherein the first access opening is located over a portion of the pair of conductive areas and a portion of the pair of lead wires electrically terminated to the portion of the conductive areas; disposing a first sealing compound in the first access opening to cover the portion of the conductive areas and the portion of the pair of lead wires located in the first access opening; disposing a second sealing compound in the second access opening after a portion of the trimable resistive film is removed to provide a desired resistance between the pair of conductive areas; and disposing a third sealing compound in the third access opening, wherein the third access opening is located over a portion of the third conductive area and a portion of the third lead wire electrically terminated to a portion of the third conductive area, wherein the third sealing compound is substantially similar to the first sealing compound.

### BRIEF DESCRIPTION OF THE DRAWINGS

FIG. 1 is a perspective view of a trim assembly constructed in accordance with an exemplary embodiment of the present invention;

FIG. 2 is an exploded perspective view of the trim assembly of FIG. 1;

FIG. 3 is a perspective view of a component part of the FIG. 1 embodiment;

FIG. 4 is a perspective view of a trim assembly received within a protective sheath;

FIG. 5 is a top plan view of a component part of the FIG. 1 embodiment;

FIGS. 6-9 illustrate alternative exemplary embodiments of the present invention;

FIG. 10 is a perspective view of a trim resistor assembly constructed in accordance with exemplary embodiments of the present invention;

FIG. 10A is a cross sectional view along lines 10A-10A of FIG. 10; and

FIG. 11 is an illustration of the trim resistor assembly electrically coupled to a gas sensor in accordance with exemplary embodiments of the present invention.

### DETAILED DESCRIPTION OF EXEMPLARY EMBODIMENTS

Reference is made to the following U.S. patent applications Ser. No. 10/472,409, filed Sep. 17, 2003; Ser. No. 11/118,153 filed Apr. 29, 2005; and Ser. No. 11/297,903, attorney docket no. DP-304209 filed Dec. 9, 2005, the contents each of which are incorporated herein by reference thereto.

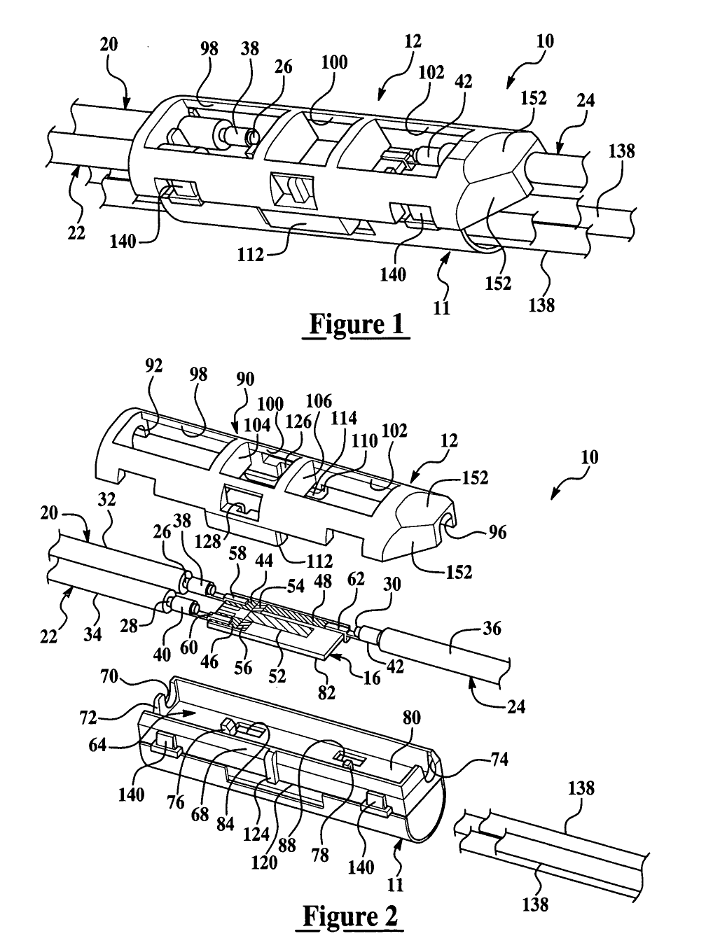

Referring now to FIGS. 1-5, a trim resistor assembly 10 constructed in accordance with an exemplary embodiment of the present invention is illustrated. Trim resistor assembly 10 comprises a first housing portion 11, a second housing portion 12 and a trim element 16. In accordance with an exemplary embodiment, trim element 16 is retained within first housing portion 11 and second housing portion 12. In accordance with an exemplary embodiment, the trim resistor assembly is configured for use with a wide range of devices and variety of associated circuit connectors.

The trim resistor element preferably includes a trimable resistive film comprising an electrically conductive material and a plurality of conductive areas, wherein at least two of the conductive areas are in electrical communication with separate areas of the trimable resistive film. In accordance with an exemplary embodiment, the trimable resistive film provides an electrical resistance between conductive areas disposed on the trim element.

In accordance with an exemplary embodiment, first housing portion 11 and second housing portion 12 are formed out of a non-conductive plastic material or polymer. One non-limiting example of the plastic material for the housing top and housing body is Valox plastic.

In one non-limiting embodiment, trim element 16 comprises a non-conductive substrate 18 with a plurality of lead wires 20, 22 and 24 each having a conductive core 26, 28 and 30 surrounded by an insulative covering 32, 34 and 36 and being secured to the substrate via a terminal 38, 40 and 42. In an exemplary embodiment, a plurality of conductive areas 44, 46 and 48 are disposed on an upper surface 50 of the non-conductive substrate and a trimable resistive film 52 is disposed on the upper surface such that at least two of the conductive areas are in electrical communication with separate portions of the resistive film.

In accordance with an exemplary embodiment, the non-conductive substrate comprises ceramic materials (e.g., AlO₂). However, the substrate may be constructed of any material suitable to the desired end purpose. In accordance with an exemplary embodiment, the trimable resistive film is preferably constructed of printed resistor ink, such as ruthenium oxide, which is applied via silk screening, printing or any other suitable process to provide the desired amount of trimable resistive film on the nonconductive surface of the substrate. Of course, trimable resistive film may comprise any conductive material suitable to the desired end purpose. As illustrated, the conductive areas comprise a conductive ink, such as palladium or any other conductive material that is applied via silk screening, printing or any other suitable process to provide the desired amount conductive areas, wherein electrical communication is provided between the conductive areas and the trimable resistive film by for example disposing a portion of the conductive area over or under a portion of the trimable resistive film to provide a pair of overlapping areas 54 and 56.

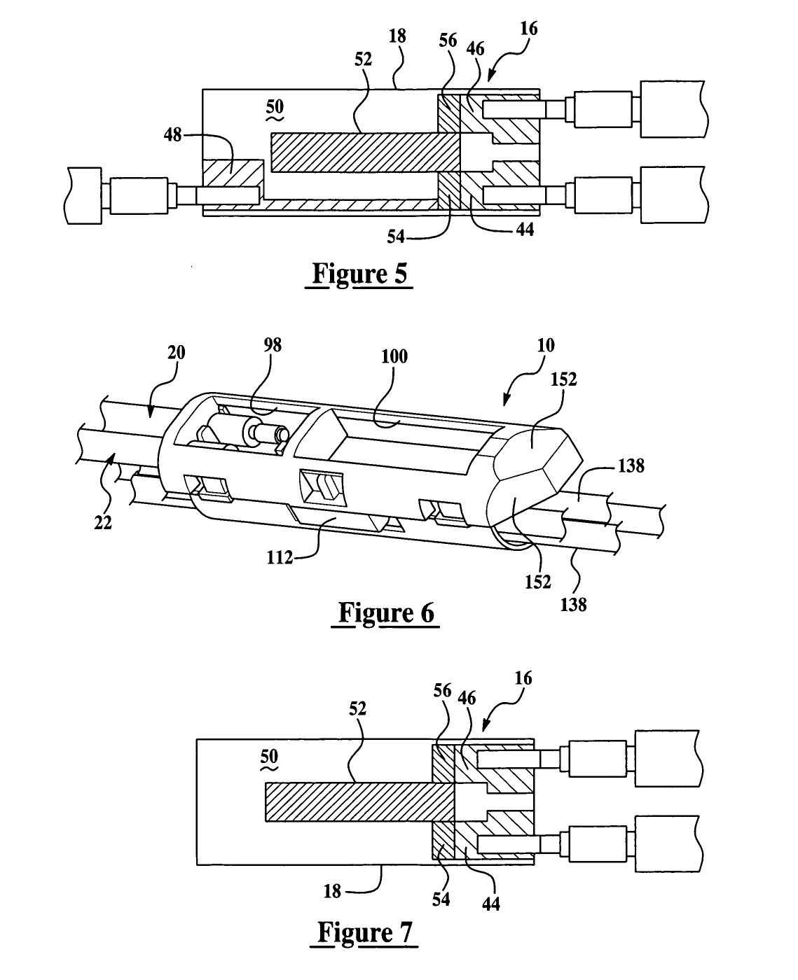

Of course, the conductive areas may comprise any conductive material that resists oxidation and that is capable of being applied to provide the conductive areas. As illustrated in FIG. 5, the nonconductive surface of the trim resistor element is configured to have three areas of conductive ink 44, 46 and 48 each being positioned for termination to an uninsulated portion of one of the lead wires in order to provide electrical communication with the same. As illustrated, electrical communication is provided with the trimable resistive film at areas 54 and 56 wherein the conductive ink of the trimable resistive film overlaps with the conductive ink of the conductive areas. It being understood that the order of conductive inks being applied does not matter as long as the overlapping of the conductive ink and the trimable resistive film occurs.

As illustrated, conductive area 44 will provide direct electrical communication with conductive area 48 thus providing numerous circuit configurations wherein the resistance value of trimable resistive film 52 is or completely bypassed. Of course, and in accordance with exemplary embodiment of the present invention, numerous other configurations are contemplated.

Referring back now to FIGS. 1-5, and in accordance with an exemplary embodiment, an electrical connection is made between the conductive areas and the terminals, wherein each terminal contacts a portion of a respective one of the conductive areas. In one non-limiting exemplary embodiment each of the terminals comprises a clip portion 58, 60 and 62 configured to make electrical contact with the conductive area as well as secure the same to the substrate. In addition, a tack weld or spot weld may be employed to secure the terminals to the substrate prior to a potting process, which will be discussed herein. Non-limiting examples of securement means for termination ends of the terminals include but are not limited to tack welding, soldering, and interference fits.

Once the terminals are secured to the substrate the trim element and the lead wires are disposed into a receiving area 64 of the first housing portion. As illustrated, a peripheral wall 68 defines receiving area 64 wherein each of the lead wires are received within a channel or opening 70, 72 and 74 located in the peripheral wall. In addition, a pair of locating tabs 76 and 78 are positioned to depend away from a bottom surface 80 of the receiving area. Tabs 76 and 78 are positioned to locate trim element in receiving area 64 wherein the clip portions located on a lower surface 82 of the substrate are received in recesses 84, 86 and 88, which are located on surface 80 such that tabs 76 and 78 and recesses allow the trim element to be located into a specific location of area 64 such that the trimable resistive film will be located for laser trimming when the first housing portion is secured to the second housing portion. In addition, channels or openings 70, 72 and 74 are positioned such that the bottom portion of openings 70, 72 and 74 are above bottom surface 80 such that the insulation of wires 32, 34 and 34 of lead wires 20, 22 and 24 is in a spaced relationship with bottom surface 80 when the wires are located in the openings. Accordingly, a gap exists between the insulation of the wires and the bottom surface such that the potting compound when applied (as will be discussed herein) will flow around the wire and seal the same to the housing.

Second housing portion 12 has a peripheral wall portion 90, which is also configured to have a plurality of channels or openings 92, 94 and 96, which are configured to allow the lead wires to pass therethrough when the first housing portion is secured to the second housing portion. Second housing portion 12 is also configured to have a first access opening 98, a second or middle access opening 100 and a third access opening 102 each of which defines a portion of, or a periphery of a reservoir for receiving a sealant or potting compound. Access openings 98, 100 and 102 are defined by peripheral wall portion 90 and a pair of inner wall portions 104 and 106. Access opening 98 is configured to be disposed over the terminals of lead wires 20 and 22 and their respective terminals, which are electrically terminated to the trim element when second housing portion 12 is secured to the first housing portion. In addition, access opening 102 is configured to be disposed over the terminal of lead wire 24 and its respective terminal, which is electrically terminated to the trim element when the first housing portion is secured to the second housing portion. Access opening 100 is configured to be located over the trimable resistive film such that the same can be removed via a laser trimming process when the first housing portion is secured to the second housing portion.

In accordance with exemplary embodiments, the access openings, the trimable resistive film and the conductive areas are configured such that only a portion of the trimable resistive film is accessible for trimming via opening 100 or alternatively all of the trimable resistive film and a portion of the conductive areas are also accessible via opening 100 and thereafter are sealed by a sealant or no portion of the conductive areas are accessible and all of the trimable resistive element is accessible or any combinations of the foregoing are contemplated wherein desired resistances are achieved by removing a portion of the trimable resistive element.

As discussed herein, one non-limiting example of the trimable resistive film is a ruthenium oxide disposed on a non-conductive surface of the trim resistor element by for example, in an ink form, wherein the trim resistor element comprises a ceramic substrate such as AlO₂ and the trimable resistive film is in electrical communication with a plurality of conductive areas disposed on the non-conductive surface of the ceramic substrate. One non-limiting example of the conductive pads are areas of conductive ink such as palladium, which are configured to overlap a portion of the conductive ink comprising the trimable resistive film providing overlapping areas, which comprise electrical contact points between the conductive pads and the trimable resistive film.

In accordance with an exemplary embodiment trim element 16 is retained in receiving area 64 by second housing portion 12 when the same is snapped onto first housing portion 11. More particularly, the bottom portions of walls 104 and 106 will make contact with the upper surface of the trim element thus, retaining the same in the receiving area. In addition, channels 92, 94 and 96 will also provide a clamping feature on lead wires 20, 22 and 24.

In order to secure the first housing portion to the second housing portion second housing portion 12 has a pair of securement features 110 and 112 each depending away from a bottom of the peripheral wall and having a shoulder portion 114 (only one shown) configured to engage a respective opening or edge 118 and 120 of first housing portion 11. In addition, first housing portion 11 has a pair of features 122 and 124 configured to slidably engage complimentary openings or slots 126 and 128 in securement features 110 and 112. Features 122 and 124 are positioned to properly locate first housing portion 11 with respect to second housing portion 12.

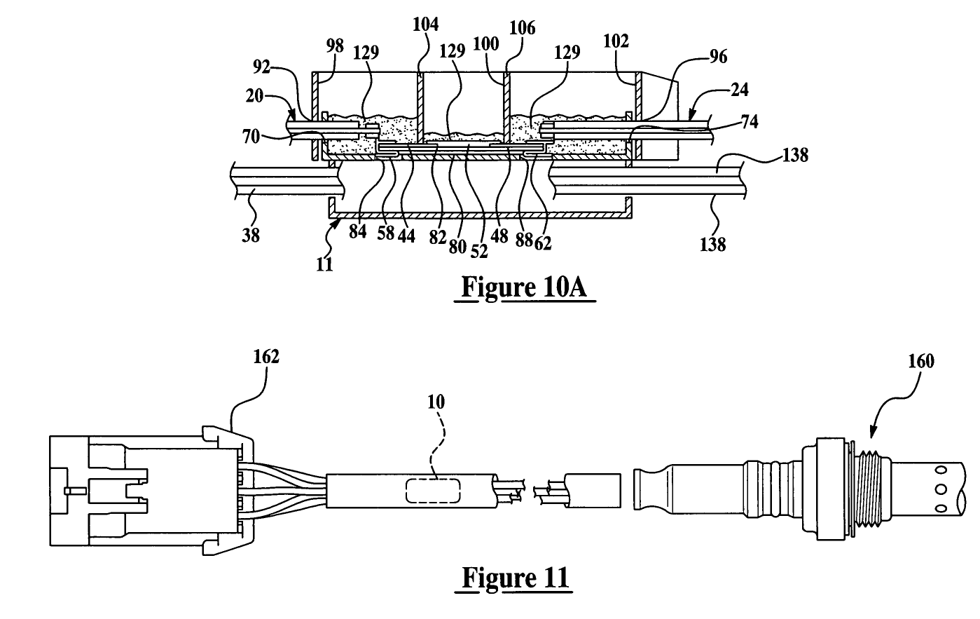

Thereafter, and once the trim element is secured between first housing portion 11 and second housing portion 12 the access openings of the lead wires 98 and 102 are filed with a potting material to permanently seal the lead wires to the trim element as well as seal the housings about the trim element. In accordance with an exemplary embodiment, any adhesive coating having non-conductive properties capable of bonding to the resistor assembly so as to form a watertight seal is contemplated. One preferred sealant is an acrylic encapsulate. FIGS. 10-10A illustrate a sealant 129 disposed in the access areas of the second housing portion. Sealant may be clear or opaque or any combination thereof. In addition and as discussed herein, different sealants of different thicknesses may be disposed in each of the access cavities or reservoirs.

In accordance with an exemplary embodiment and after the potting of access openings 98 and 102 or alternatively before the potting of openings 98 and 102 portions of the trimable resistive film are removed to adjust the resistance of a conductive path between the conductive areas and the conductive cores of lead wires 20 and 22. This is preferably done by a laser trimming process wherein a laser beam will make a series of passes over the trimable resistive element by for example, in an “I”, “L”, “J” or hook patterns which can be inverted, wherein the desired amount of the resistive film of the resistive element is removed to provide an electrical conduit or path between the conductive pads, which has a known resistive value. Of course, any configuration is contemplated (e.g., zigzag) as long as there is a conductive path between the conductive pads.

Once the laser has been communicated with a predetermined starting position, the laser beam then removes a portion of the trimable resistive film by cutting into the resistive element until a desired resistance is achieved between lead wire 20 and 22. In accordance with an exemplary embodiment, additional laser cuts may be used to further refine the resistance by for example, removing portions of the resistive element.

In accordance with an exemplary embodiment, the resistance of the trimable resistive film may be measured via a passive trim approach or via an active trim approach. One type of passive trim measurement approach, which may or may not be performed during the lasing process, measures the resistance of trimable resistive film by probing either one of the conductive areas in electrical communication with the trimable resistive film, using any resistance measurement device suitable to the desired end purpose. If the resistance is being measured during the lasing process, the laser will terminate lasing once a desired resistance is achieved. If the resistance is not being measured during the lasing process, the resistance will be measured following a laser cut. If the resistance is not as desired, the lasing processes will be repeated until a desired resistance is achieved. Another type of passive trim measurement approach would be to calculate, using the property characteristics of trimable resistive film, how much of the trimable resistive film must be removed in order to achieve a desired resistance. Once this is calculated, the laser may be precisely controlled to remove the calculated quantity.

In accordance with an exemplary embodiment, under an active trim measurement approach, which also may or may not be performed during the lasing process, the trim resistor assembly is connected to a desired device, such as a sensor wherein a known condition is applied to an input of the device and the output of the device is monitored and the resistance of the trim resistor assembly is adjusted, as discussed hereinabove, until a desired output of the device is achieved.

In accordance with an exemplary embodiment, although the resistance of the trimable resistive film is explained hereinabove as being adjusted using a laser, the resistance may be adjusted using any suitable adjustment method or device, such as sandblasting, high pressure air or water cutting. In addition, the laser that is used may be any laser that abates material.

Thereafter, and after the trimming process, a sealant or potting compound is disposed in the area defined by access opening 100. As illustrated, access openings 98, 100 and 102 are configured to define discrete areas or reservoirs for receipt of a potting compound or sealant therein. Moreover, and since three separate areas are provided, three different types of potting compounds or sealants may be applied at different times and thicknesses. For example, and in areas 98 and 102 a thicker amount of sealant is required to cover and secure the terminations of the wires to the trim element and the housing as opposed to the center access opening 100, wherein the required thickness is only necessary to cover the conductive inks disposed on the non-conductive substrate.

In addition, and since the insulative covers of some of the lead wires in an exemplary embodiment will comprise a PTFE (Polytetrafluoroethylene) material. Accordingly, there are certain potting compounds more suitable for use with PTFE coated materials as opposed to the sealant that is required or is more suitable for center access opening 100. In addition, the PTFE containing coatings may be etched via an etching process to provide a roughened surface for receipt of the appropriately selected potting compound. For example, the etching of the PTFE insulation may be achieved with a sodium ammonia or sodium naphthalene so that the surface of the PTFE insulation is chemically modified for adhesion to various potting compounds or sealants, such as commercial grade epoxies selected for the contemplated end use of the trim resistor assembly as the heat resistance of the epoxy must be matched to the application environment. Thus, a first sealant may be used in opening 102, which may comprise a sealant suitable for use with a wire covering comprising PTFE and a second sealant is disposed in opening 98, wherein the second sealant is different from the first sealant as the wires disposed therein may not have an insulative covering comprising PTFE and finally a third sealant is disposed in cavity or opening 100, wherein the third sealant is different from the first and second sealants and is suitable for covering the trimable resistive film of the resistor assembly. In addition, the thickness and required potting times may vary with the various sealants due to their characteristics and amount (e.g., thickness) required. Also, the sealants may be disposed and cured in areas 98 and 102 prior to the trimming process. Alternatively, areas 98 and 102 may be filled with sealants after or during the same time the sealant is applied to area 100, which is of course after the trimming process.

In an exemplary embodiment, a hermetic seal is provided in each of the access areas. As used herein and in an exemplary embodiment, hermetic seal is defined as <0.5 cc/min of leakage at an applied pressure 7-7.5 psi. Of course, leakage rates greater or less than the aforementioned values are also contemplated for use in exemplary embodiments of the present invention.

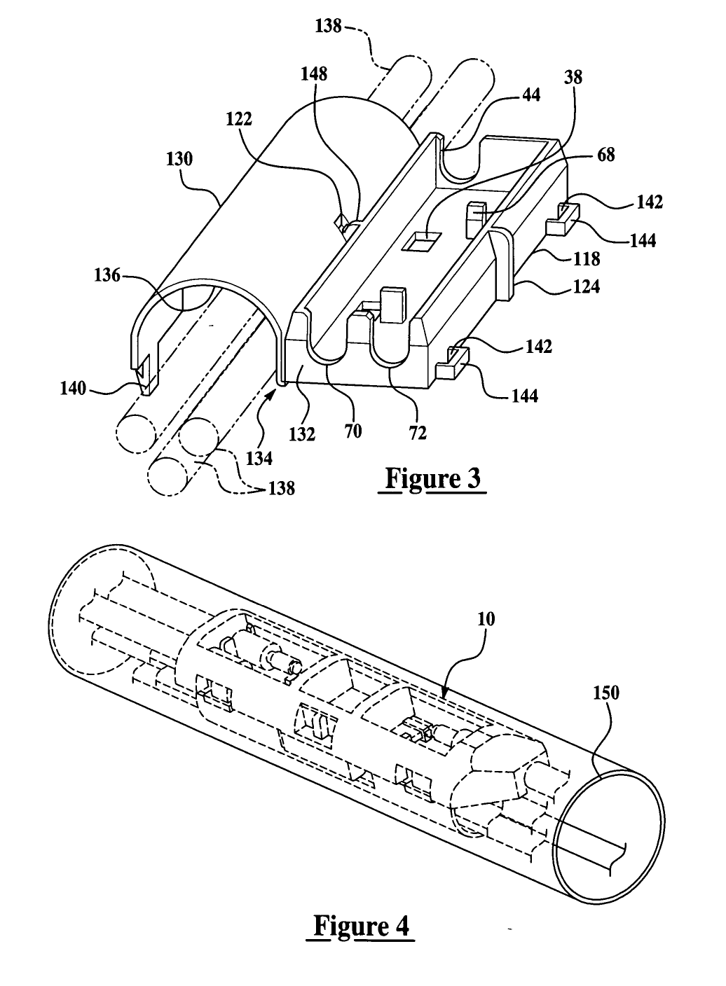

Referring now to FIGS. 1 and 3, first housing portion 11 is configured to have a shell portion 130 pivotally secured to a lower portion 132 of the peripheral wall defining the receiving area via living hinge 134. Shell portion 130 is configured to define an elongated opening 136 for receipt of a plurality of sensor wires 138, which are not directly secured to the trim element. In order to secure shell portion 130 to the peripheral wall a plurality of tabs 140 are configured to engage respective tab openings 142 defined by features 144 disposed proximate to the peripheral wall on a side opposite to the living hinge.

In accordance with an exemplary embodiment, and referring now to FIG. 3 when shell portion 130 is in the illustrated configuration, wires 138 are disposed laterally away from receiving area such that laser trimming of the trim element may occur without wires 138 being inadvertently being cut by the laser. In addition, and in one non-limiting embodiment shell portion 130 may be configured to have an opening 148 configured to receive feature 122 therein when the shell portion is in the illustrated configuration.

FIG. 4 illustrates the trim resistor assembly after the trimming and sealing process wherein the trimable resistive assembly is located within a protective sheath 150. As illustrated, trim resistor assembly 10 comprises a somewhat circular shape or external periphery configured to be received within the protective sheath. In addition, second housing portion 12 is configured to have a plurality of chamfered surfaces 152 in order to facilitate the sliding of trim resistor assembly into the protective sheath.

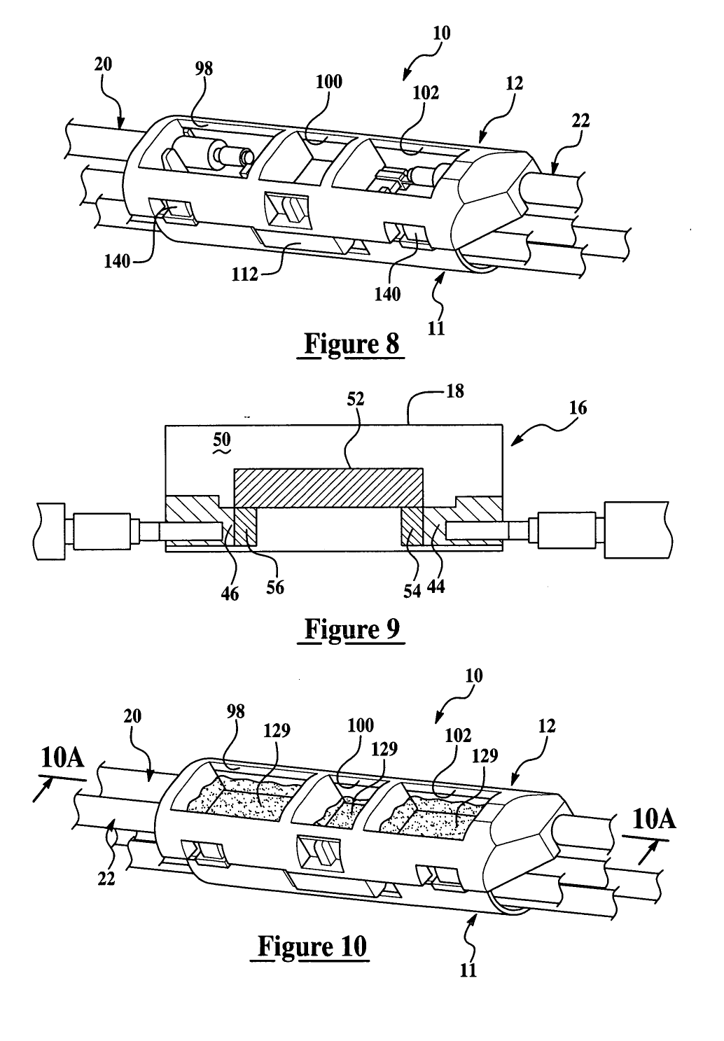

Referring now to FIGS. 6 and 7 an alternative exemplary embodiment of the present invention is illustrated. Here the trim element is configured to have only a pair of wire terminals secured thereto and second housing portion is configured to only have a pair of access openings. FIGS. 8 and 9 illustrate yet another alternative configuration wherein two lead wires and three access openings are used.

In accordance with an exemplary embodiment, the resistor assembly is assembled as follows, after the terminals are attached to the ceramic substrate, the sub-assembly of the terminals and the ceramic substrate is set into the receiving area of the bottom housing. Then the top housing is snapped onto the bottom housing.

Thereafter, the potting compound is applied to the reservoirs disposed on either side of the central opening or in the case of the two opening housing the potting compound is applied to one of the reservoirs. The potting compound will completely seal the wires in place as well as sealing off the connections. The potting compound enhances the maximum pull capability of the wires, especially a PTFE wire, since it is known how difficult it is to seal to PTFE wires. Of course, etching the wires will help this process. Moreover, and in one contemplated use and as illustrated in FIG. 11, the resistor assembly is part of a wiring harness of a gas sensor 160, wherein the insulation of lead wire 24 comprises PTFE as is travels towards gas sensor 160, which in one implementation is disposed in an adverse environment having high temperatures while lead wires 20 and 22 traverse towards an offend connector 162. A non-limiting example of such an environment is an exhaust system of an internal combustion engine, wherein the gas sensor is disposed to sense exhaust gases of the internal combustion engine.

Once the cavities associated with the terminal connections are filled the center cavity or the cavity associated with the trimable resistive element is open for laser trimming of the resistive film. The cavities are designed to allow flowing of the potting compound into all areas desired leaving an extra gap if necessary to assure proper flow of material below the lead wires. For example, the configuration of channels or openings 70, 72 and 74 is such that the insulation of the lead wires is in a facing spaced relationship with regard to the bottom surface (FIG. 10A), wherein sealant is disposed above and below the lead wires. The viscosity of the sealant applied will also have an effect on the amount of gap required. In one non-liming example, a gap of approximately 0.13 mm is provided between the bottom surface and the insulation of the wire. Of course, gaps greater or less than the aforementioned values are considered to be with the scope of exemplary embodiments of the present invention. In one exemplary embodiment three different compartments allow for the possibility of using different potting compounds, possibly one for PTFE wire, one for the other wire, and one for sealing the trim resistor cavity.

In addition, after laser trimming the resistor, the center cavity only needs to be filled part way since the rest of the assembly has already been sealed; this allows for a very quick curing of the potting compound after trimming since the thickness is less than would be otherwise necessary if all three cavities were tied together (since the potting compound must be above the height of the wires).

The living hinge on the bottom housing is used to contain the other wires. This is especially important during laser trim to ensure none of the wires are cut by the laser. This hinge may be activated before the other wires are fed through or wrapped around the other wires of the harness during harness assembly. While a separate piece may be used for this function, a living hinge eliminates assembly steps and hand motions.

After the assembly has the trim resistor potted, the whole assembly is slipped underneath the protective wire sheath as shown in FIG. 4. This prevents the assembly from getting caught and protects the assembly from damage. The design allows the assembly to fit in a conventional sleeve.

While one exemplary embodiment illustrates three wires, and one resistor, other exemplary embodiments contemplate two wires (independent loop), or more than three wires with more than one trim resistors. The present invention has an advantage of decreasing the amount of terminals required on the off end connection since two of the wires are common with each other. Some sensors might require two or more trim resistors, which would require additional wires and exemplary embodiments of the present invention are contemplated for use with such configurations.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A resistor assembly, comprising:
a first housing portion, the first housing portion having a receiving area on one side of the first housing portion;
a trim resistor element disposed in the receiving area, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film;
a pair of lead wires, one of the pair of lead wires being electrically terminated with one of the pair of conductive areas and the other one of the pair of lead wires being secured to the other one of the pair of conductive areas; and
a second housing portion, the second housing portion having a first access opening and a second access opening, the second housing portion being disposed over the receiving area after the trim resistor element has been located therein, wherein the first access opening is located over a portion of the pair of conductive areas and a portion of the pair of lead wires electrically terminated to the portion of the conductive areas, wherein a first sealing compound is disposed in the first access opening to cover the portion of the conductive areas and the portion of the pair of lead wires located in the first access opening, and the second access opening is located over the trimable resistive film, wherein a second sealing compound is disposed in the second access opening after a portion of the trimable resistive film is removed to provide a desired resistance between the pair of conductive areas.

2. The resistor assembly as in claim 1, wherein the first housing portion further comprises an elongated opening disposed below the receiving area of the first housing portion.

3. The resistor assembly as in claim 2, wherein the elongated opening is formed by a shell member pivotally secured to the first housing portion by a living hinge, the shell member having a plurality of tabs configured to snap fittingly engage complementary tab openings located on the first housing portion.

4. The resistor assembly as in claim 3, wherein the shell member is “U” shaped and the elongated opening is configured to receive a plurality of wires of a wire harness.

5. The resistor assembly as in claim 3, wherein the wire harness and the pair of leads are electrically coupled to a gas sensor of an exhaust system.

6. The resistor assembly as in claim 1, wherein the second portion is configured to snap fittingly engage the first housing portion, wherein the first housing portion and the second housing portion each comprise a pair of channels configured to secure the pair of lead wires thereto, wherein the pair of channels of the first housing portion are configured to located the pair of wires in a spaced relationship with respect to a bottom surface of the receiving area.

7. The resistor assembly as in claim 1, wherein the second portion has a pair of tabs configured to frictionally engage a pair of engagement openings of the first portion.

8. The resistor assembly as in claim 7, wherein the pair of tabs are each configured to have a shoulder portion to frictionally engage the pair of engagement openings of the first portion.

9. The resistor assembly as in claim 1, wherein the portion of the trimable resistive film is removed by a laser trimming process.

10. The resistor assembly as in claim 1, wherein the non-conductive substrate comprises a ceramic material and the pair of conductive areas and the trimable resistive film comprise a conductive ink disposed on the ceramic material, and wherein the conductive ink of the pair of conductive areas comprises palladium and the conductive ink of the trimable resistive film comprises ruthenium.

11. The resistor assembly as in claim 6, wherein the first sealing compound is disposed above and below the portion of the pair of lead wires in the first access opening.

12. The resistor assembly as in claim 1, wherein the first sealing compound is disposed in the first access opening to cover the portion of the conductive areas and the portion of the pair of lead wires located in the first access opening at a first thickness, and the second sealing compound is disposed in the second access opening at a second thickness to cover the trimable resistive film, wherein the first thickness is greater than the second thickness.

13. The resistor assembly as in claim 1, wherein the first sealing compound comprises a different composition than the second sealing composition.

14. The resistor assembly as in claim 1, wherein one of the pair of lead wires comprises an insulative covering comprising PTFE.

15. The resistor assembly as in claim 1, wherein each of the pair of lead wires comprises an insulative covering and a conductive core, the conductive core being secured to a terminal and the terminal is secured to a respective one of the pair of conductive areas, wherein the receiving area is configured to have a plurality of terminal openings or receptacles configured to receive a portion of the terminal when the trim resistor element is disposed in the receiving area.

16. The resistor assembly as in claim 1, wherein the first access area and the second access are separated by a wall portion and the wall portion retains the trim resistor element in the receiving area when the first housing portion is secured to the second housing portion.

17. A resistor assembly, comprising:
a first housing portion, the first housing portion having a receiving area on one side of the first housing portion;
a trim resistor element disposed in the receiving area, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film;
a third conductive area disposed on the non-conductive substrate, the third conductive area being in direct electrical communication with one of the pair of conductive areas via a conductive path that does not include the trimable resistive film;
a pair of lead wires, one of the pair of lead wires being electrically terminated with one of the pair of conductive areas and the other one of the pair of lead wires being secured to the other one of the pair of conductive areas;
a third lead wire electrically terminated with the third conductive area; and
a second housing portion, the second housing portion having a first access opening, a second access opening and a third access opening, the second housing portion being disposed over the receiving area after the trim resistor element has been located therein, wherein the first access opening is located over a portion of the pair of conductive areas and a portion of the pair of lead wires electrically terminated to the portion of the conductive areas, wherein a first sealing compound is disposed in the first access opening to cover the portion of the conductive areas and the portion of the pair of lead wires located in the first access opening, and the second access opening is located over the trimable resistive film, wherein a second sealing compound is disposed in the second access opening after a portion of the trimable resistive film is removed to provide a desired resistance between the pair of conductive areas and the third access opening is located over a portion of the third conductive area and a portion of the third lead wire electrically terminated to a portion of the third conductive area, wherein a third sealing compound is also disposed in the third access opening to cover the portion of the third conductive area and the portion of the third lead wire located in the third access opening.

18. The resistor assembly as in claim 17, wherein the first housing portion further comprises an elongated opening disposed below the receiving area of the first housing portion.

19. The resistor assembly as in claim 18, wherein the elongated opening is formed by a shell member pivotally secured to the first housing portion by a living hinge, the shell member having a plurality of tabs configured to snap fittingly engage complementary tab openings located on the first housing portion and, wherein the second portion is configured to snap fittingly engage the first housing portion.

20. The resistor assembly as in claim 19, further comprising a wire protection sheath disposed about the resistor assembly and wherein the third lead wire comprises an insulative covering comprising PTFE and the third sealing compound is different from the first sealing compound, the third sealing compound being suitable for insulative coverings comprising PTFE.

21. The resistor assembly as in claim 19, wherein the first housing portion and the second housing portion each comprise a plurality of channels configured to secure the pair of lead wires and the third lead wire thereto, wherein the plurality of channels of the first housing portion are configured to locate the pair of wires and the third lead wire in a spaced relationship with respect to a bottom surface of the receiving area, wherein a portion of the first sealing compound is received between the pair of lead wires and a portion of the bottom surface and a portion of the third sealing compound is received between the third lead wire and another portion of the bottom surface of the receiving area.

22. The resistor assembly as in claim 21, wherein the third lead wire comprises an insulative covering comprising PTFE and the third sealing compound is different from the first sealing compound, the third sealing compound being suitable for insulative coverings comprising PTFE.

23. A method for providing a resistor assembly, the method comprising:
disposing a trim resistor within a receiving area of a first housing portion, the trim resistor element comprising a non-conductive substrate, a trimable resistive film disposed on a surface of the non-conductive substrate, a pair of conductive areas each being disposed on the non-conductive substrate in a discrete location, each one of the pair of conductive areas being in electrical contact with separate portions of the trimable resistive film, wherein a conductive path between the pair of conductive areas is defined by the trimable resistive film and a third conductive area disposed on the non-conductive substrate, the third conductive area being in direct electrical communication with one of the pair of conductive areas;
terminating a pair of lead wires to the trim resistor element, one of the pair of lead wires being electrically terminated with one of the pair of conductive areas and the other one of the pair of lead wires being secured to the other one of the pair of conductive areas;
terminating a third lead wire with the third conductive area;
securing a second housing portion to the first housing portion after the trim resistor element is disposed in the receiving area, the second housing portion having a first access opening, a second access opening and a third access opening, wherein the first access opening is located over a portion of the pair of conductive areas and a portion of the pair of lead wires electrically terminated to the portion of the conductive areas;
disposing a first sealing compound in the first access opening to cover the portion of the conductive areas and the portion of the pair of lead wires located in the first access opening;
disposing a second sealing compound in the second access opening after a portion of the trimable resistive film is removed to provide a desired resistance between the pair of conductive areas; and
disposing a third sealing compound in the third access opening, wherein the third access opening is located over a portion of the third conductive area and a portion of the third lead wire electrically terminated to a portion of the third conductive area, wherein the third sealing compound is substantially similar to the first sealing compound.

24. The method as in claim 23, wherein a thickness of the first and third sealing compounds disposed in the first and third access openings is greater than a thickness of the second sealing compound disposed in the second access opening.

25. The method as in claim 23, wherein the first housing portion and the second housing portion each comprise a plurality of channels configured to secure the pair of lead wires and the third lead wire thereto, wherein the plurality of channels of the first housing portion are configured to locate the pair of wires and the third lead wire in a spaced relationship with respect to a bottom surface of the receiving area, wherein a portion of the first sealing compound is received between the pair of lead wires and a portion of the bottom surface and a portion of the third sealing compound is received between the third lead wire and another portion of the bottom surface of the receiving area.

26. The method as in claim 25, wherein the third lead wire comprises an insulative covering comprising PTFE and the third sealing compound is different from the first sealing compound, the third sealing compound being suitable for insulative coverings comprising PTFE.
